(19) United States
(12) Patent Application Publication
(10) Pub. No.: US 2006/0218130 A1
(43) Pub. Date: Sep. 28, 2006

(54) Software-and-hardware resource

(75) Inventors: Wen-Chang Chang, Taipei City (TW); Mei-Yun Lin, Taipei City (TW)

Correspondence Address: REED SMITH LLP, Suite 1400, 3110 Fairview Park Drive, Falls Church, VA, 22042, US

(73) Assignee: Inventec Corporation

(21) Appl. No.: 11/090,098

(22) Filed: Mar. 28, 2005

(51) Int. Cl. G06F 17/30

(52) U.S. Cl. 707/3

(57) ABSTRACT

A management system for the software-and-hardware resource is disclosed. The management system comprises a data server and web server. The web server further comprises a software-and-hardware resource management module which includes software-and-hardware resource related data setup sub-module; software-and-hardware resource status handling sub-module; software-and-hardware resource query module; software-and-hardware resource report module; as well as software-and-hardware resource past-due lending-out return urging module. In addition, the invention discloses a management method that comprises providing a software-and-hardware resource item number coding; performing software-and-hardware resource related data setup; printing software-and-hardware resource bar code label. The management method also comprises providing software-and-hardware resource query and report; providing software-and-hardware resource status handling; as well as providing urging handling for the software-and-hardware resource past-due lending-out. The invention can facilitate query on the storing location and the lending-out status of the software-and-hardware resource for the users. What is more, through the intranet of a corporation, the invention can facilitate the control on all the software-and-hardware resources within the corporation for the supervisors.

### BACKGROUND OF THE INVENTION

1. Field of the Invention

The invention relates to a management system and its method for the software-and-hardware resource, and more particularly, to a management system and its method for the software-and-hardware resource used within a corporation for managing software-and-hardware resource.

2. Description of the Prior Art

Material management is the most important segment in the operation of a corporation. Since software-and-hardware resource is one of the important materials within a corporation, it is necessary to control accurately the up-to-date status of the software-and-hardware resource. Therefore, it is necessary that one wholly control the receiving of the software-and-hardware resource, the storing location, check-in and check-out condition, as well as borrowers. In this way, one can accomplish to that extent that the account matches the material, and that one can meet the urgent needs of handling emergencies.

Conventional material management utilizes manual method or computer system key-in to record the inventory as well as lending-out and returning of the software-and-hardware resource. This is not only time-consuming but also apt to make mistake in recording. What is more, that the habit that the users tend to take for use beforehand and to make up recording afterward often results in the situation that the account does not match the material. Especially, when it comes to checking inventory, it will need a lot of labor and materials. The even worse situation is that one is completely out of control on the whereabouts and quantity of the inventory once the materials are urgently demanded.

Furthermore, there are various kinds of software-and-hardware resources; various kinds of extension cards such as network card, SCSI card, RAID card; various kinds of devices such as hard disk, compact disk, keyboard, mouse; various kinds of USB devices; and various kinds of software. Just how to use these software-and-hardware resources efficiently and how to manage these software-and-hardware resources systematically has become an important issue nowadays.

In view of the above-mentioned situations, the invention presents a management system and its method for the software-and-hardware resource aiming at resolving the shortcomings of managing the conventional software-and-hardware resource.

### SUMMARY OF THE INVENTION

In light of the disadvantages of the prior arts, the invention provides a management system and its method for the software-and-hardware resource that aims to ameliorate at least some of the disadvantages of the prior art or to provide a useful alternative.

One of the objectives of the invention is to provide a management system of the software-and-hardware resource to controls the up-to-date status of the whole software-and-hardware resource.

It is another objective of the invention to provide a management system of the software-and-hardware resource such that the user can easily query the up-to-date status of the whole software-and-hardware resource through the intranet of a corporation.

It is a further objective of the invention to provide a management system of the software-and-hardware resource such that the supervisor can also control the usage status of the user through the system.

To attain the above-mentioned objectives, the invention provides a management system for the software-and-hardware resource that comprises a data server for storing the overall data of the system, and a web server. The web server further comprises a software-and-hardware resource management module that includes software-and-hardware resource related data setup sub-module and software-and-hardware resource status handling sub-module. The web server further comprises a software-and-hardware resource query module with new item query web pages and advanced resource query web pages. The web server further comprises a software-and-hardware resource report module with new item query web pages and advanced resource query web pages. The web server further comprises a software-and-hardware resource past-due lending-out return urging module having querying past-due lending-out users and their past-due software-and-hardware resources.

In addition, the invention discloses a management method that comprises providing a software-and-hardware resource identification coding; performing software-and-hardware resource related data setup; printing software-and-hardware resource bar code label. The management method also comprises providing software-and-hardware resource related data query and report as well as providing software-and-hardware resource status handling; as well as providing software-and-hardware resource past-due lending-out return urging handling.

The management system and its method for the software-and-hardware resource of the invention have the advantages that can perform at least the following functions

(1) The receiving function of the newly introduced software-and-hardware resource, e.g. new material receiving and notification.

(2) The software-and-hardware resource related management function, e.g. version management, asset coding management, and storing location management.

(3) The software-and-hardware resource related management function, e.g. lending-out, returning, renewing, maintenance, and scrapping.

(4) The software-and-hardware resource related management function, e.g. new item query, advanced query, and report.

(5) Lending-out past-due return urging function

By use of the management system of the invention, the supervisor not only can control the up-to-date status of the whole software-and-hardware resource but can easily query the up-to-date status of the whole software-and-hardware resource through the system as well.

### BRIEF DESCRIPTION OF THE DRAWINGS

The accomplishment of this and other objectives of the invention will become apparent from the following description and its accompanying drawings of which:

FIG. 1 is a schematic drawing of the system framework of the management system of the software-and-hardware resource of the invention;

FIG. 2A is a web page schematic drawing of the software-and-hardware resource related data setup sub-module of the invention;

FIG. 2B is a web page schematic drawing of the software-and-hardware resources status handling sub-module of the invention; and

FIG. 3 is a main flow chart of the operation of “the management system and its method” of the software-and-hardware resource of the invention.

### DETAILED DESCRIPTION OF THE PREFERRED EMBODIMENT

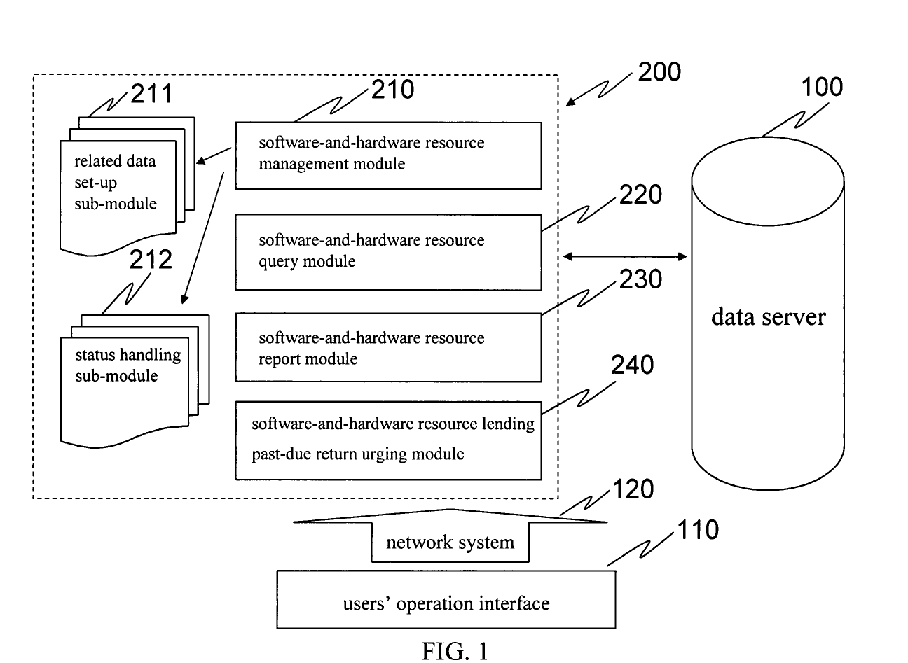

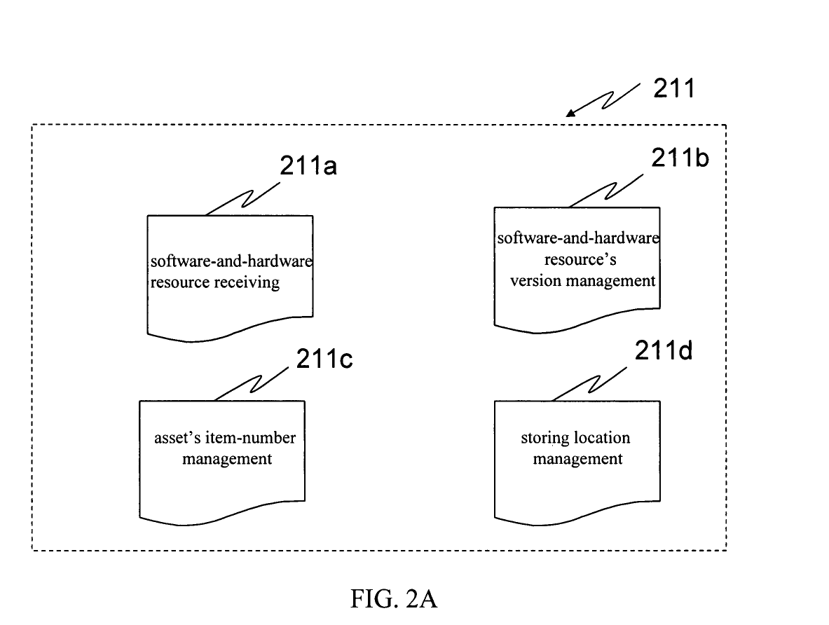

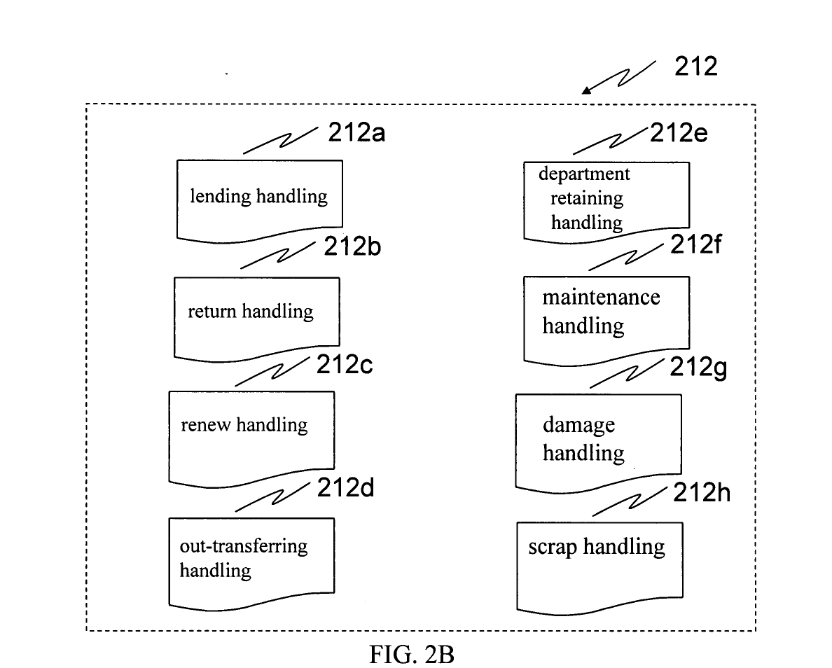

The invention is a management system and its method for the software-and-hardware resource. Now, please refer to FIG. 1 and FIG. 2A-2B. Among them, FIG. 1 is a schematic drawing of the system framework of the management system of the software-and-hardware resource of the invention. Besides, FIG. 2A is a web page schematic drawing of the software-and-hardware resource related data setup sub-module of the invention, and FIG. 2B is a web page schematic drawing of the software-and-hardware resources status handling sub-module of the invention. The management system for the software-and-hardware resource disclosed by the invention includes at least a data server (100) and a web server (200). To get into the web server (200), users must go through the users' operation interface (110) to connect to the network system (120). During the process of performing the whole software-and-hardware resource management of the software-and-hardware resource management system of the invention, the software-and-hardware resource management system includes a software-and-hardware resource management module (210) that further includes a software-and-hardware resource related data setup sub-module (211) and a software-and-hardware resource status handling sub-module (212); a software-and-hardware resource query module 220; a software-and-hardware resource report module (230); and a software-and-hardware resource lending-out past-due return urging module (240). The above-mentioned modules are explained as follows:
(a) The software-and-hardware resource management module (210) further includes software-and-hardware resource related data setup sub-module (211) and software-and-hardware resource status handling sub-module (212). The software-and-hardware resource related data setup sub-module (211) having software-and-hardware resource receiving web page (211a), software-and-hardware resource's version management web page (211b), asset's item-number management web page (211c), storing location management web page (211d). Among them, software-and-hardware resource receiving web page (211a) is for registering newly arrived data content of the software-and-hardware resource, e.g. product item number, vendor, model number, classification, description, quantity, unit storing location, and notifying users of the receiving. The software-and-hardware resource material after receiving can list the bar code label through the system to facilitate the follow-up management and control. The software-and-hardware resource's version management web page (211b) is for storing the special version data of the software-and-hardware resource, for example, a certain computer card accommodates different hardware or different firmware. The asset's item-number management web page (211c) is for storing the item number of the software-and-hardware resource. As for the storing location management web page (211d), it is for changing the storing location data.

The software-and-hardware resource status handling sub-module (212) includes lending-out handling web page (212a) for handling software-and-hardware resource lending-out data, return handling web page (212b) for handling software-and-hardware resource return data, and renew handling web page (212c) for handling software-and-hardware resource renew data. The software-and-hardware resource status handling sub-module (212) also includes out-transfer handling web page (212d) for handling the changing data of safe-keeping department or safekeeping individual, department retaining handling web page (212e) for handling special software-and-hardware resource to retain the non-lending data in a certain department, and maintenance handling web page (212f) for handling software-and-hardware resource maintenance records. Moreover, the software-and-hardware resource status handling sub-module (212) also includes damage handling web page (212g) for handling software-and-hardware resource damage records; and scrap handling web page (212h) for handling software-and-hardware resource scrap records.
(b) The software-and-hardware resource query module (220) further includes newly arrived product query and general advanced query. The former can select receiving date to obtain software-and-hardware resource data in a certain period, while the latter can let the user obtain relevant data by checking to choose various query conditions.
(c) The software-and-hardware resource report module (230) further includes newly arrived product report and general advanced query report. The former can choose receiving date to obtain the software-and-hardware resource data of a certain period wherein the data are displayed on the screen to let the user generate printout in accordance with the listed report. While the latter can let the user obtain relevant data by checking items to choose various query conditions wherein the data are displayed on the screen to let the user generate printout in accordance with the listed statement.
(d) The software-and-hardware resource lending-out past-due return urging module (240) includes querying past-due borrower and his or her software-and-hardware resource data and notification data. The system supervisor has the authority to use all the modules, while the general users can use only the software-and-hardware resource query module and the software-and-hardware resource report module. To speed up the receiving operation, the system further possesses the receiving operation function that can input the whole batch for the software-and-hardware resource of a certain product.

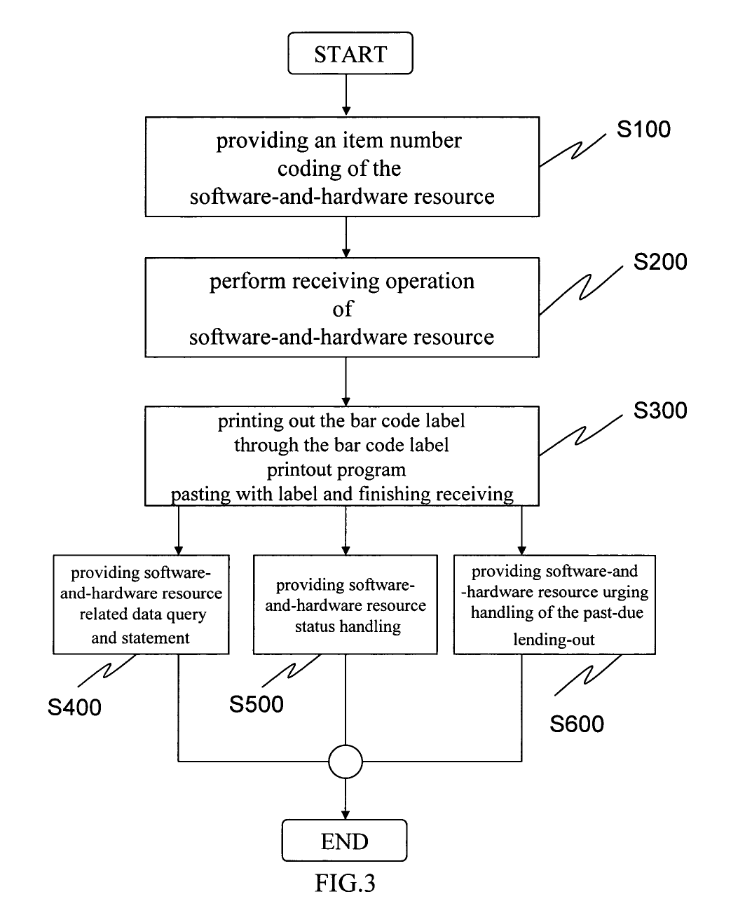

Please refer next to FIG. 3, a main flow chart of the operation of “the management system and its method” of the software-and-hardware resource of the invention is illustrated as follows

To begin with, in the management system of the software-and-hardware resource of the invention, the supervisor, based on the set-up item number coding of the software-and-hardware resource (step S100), performs the software-and-hardware resource receiving operation (step S200). After finishing the receiving operation, the system will store such information like product item number, vendors, model number, classification, description, quantity, unit, and storing location of the software-and-hardware resource. At the same time as the receiving operation, the system will create a receiving transaction record and grasp the receiving transaction record to print out the bar code label of the software-and-hardware resource through the bar code label printout program (step S300). Soon after the newly arrived software-and-hardware resource is pasted with label and the receiving is finished, the supervisor will notify the users of new product receiving through e-mail. In this way, the users can query such items as newly arrived products, general-and-advanced query, obtaining statement data, and individual borrowing details through the user's interface (step S400). Moreover, the supervisor can, depending on users' requirements, perform software-and-hardware resource status handling such as lending-out handling, return handling, renew handling, transfer handling, department retaining handling, damage handling, and scrap handling etc. Each of the above-mentioned handlings makes use of the assistance of the bar code machine (step S500). What is more, for urging handling, the supervisor can take action to perform lending-out urging by printing out the past-due borrowers and all of the software-and-hardware resource tables of what he or she has borrowed to notify the borrower through e-mail (step S600).

The “software-and-hardware resource management system and its method” of the invention having the advantages over the prior arts that it not only can control the up-to-date status of all the software-and-hardware resources, the users can easily query the up-to-date status of all the software-and-hardware resources through the intranet of a corporation as well. What is more, the supervisor can control the users' usage status too.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A management system of a software-and-hardware resource, comprising:
a data server, for storing all the data of the system; and
a web server, further comprising:
a software-and-hardware resource management module, for providing an interface for the software-and-hardware resource data setup;
a software-and-hardware resource query module, for providing an interface for the software-and-hardware resource query;
a software-and-hardware resource report module, for providing an interface for the software-and-hardware resource report; and
a software-and-hardware resource lending-out past-due return urging module, for providing an interface of querying past-due borrowers and its past-due borrowing software-and-hardware resource, as well as an interface of return urging notification.

2. The management system of a software-and-hardware resource as claimed in claim 1, wherein the software-and-hardware resource management module further comprises:
a software-and-hardware resource related data setup sub-module including software-and-hardware resource receiving web page, software-and-hardware resource version management web page, asset coding management web page, storing location management web page ;and
a software-and-hardware resource status handling sub-module including lending-out handling web page, return handling web page, renew handling web page, transfer handling web page, department retaining handling web page, maintenance handling web page, damage handling web page, scrap handling web page.

3. The management system of a software-and-hardware resource as claimed in claim 1, wherein the software-and-hardware resource query module further comprises a newly arriving product query and a general advanced query.

4. The management system of a software-and-hardware resource as claimed in claim 1, wherein the software-and-hardware resource report module further comprises : newly arrive product report where data are displayed on the screen and users can generate printout in accordance with the listed report, and a general advanced query report where data are displayed on the screen and users can generate printout in accordance with the listed report.

5. The management system of a software-and-hardware resource as claimed in claim 1, wherein the interface of the urging notification includes urging function by the use of e-mail.

6. The management system of a software-and-hardware resource as claimed in claim 1, wherein the software-and-hardware resource related data setup sub-module further includes a bar code label printing system.

7. A management method of a software-and-hardware resource for using in an executable software-and-hardware resource management, comprising the following steps:
providing a software-and-hardware resource item number coding;
performing a software-and-hardware resource related data setup;
printing software-and-hardware resource bar code and pasting label to finish receiving;
providing software-and-hardware resource related data query and statement;
proving software-and-hardware resource status handling; and
providing urging handling for the software-and-hardware resource past-due lending-out.

8. The management method of a software-and-hardware resource as claimed in claim 7, wherein the step of printing software-and-hardware resource bar code and pasting label to finish receiving further comprises a step of notifying new product receiving by the use of e-mail.

9. The management method of a software-and-hardware resource as claimed in claim 7, wherein the step of providing urging handling for the software-and-hardware resource past-due lending-out further comprises a step of notifying past-due urging by the use of e-mail.
